(19) United States
(12) Patent Application Publication
(10) Pub. No.: US 2005/0090963 A1
(43) Pub. Date: Apr. 28, 2005

(54) Device for controlling at least one control and/or regulating system arranged in a vehicle

(76) Inventors: Klaus-Peter Kuhn, Phuderhausen (DE); Andreas Proettel, Leutenbach (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/497,685

(22) PCT Filed: Nov. 28, 2002
(86) PCT No.: PCT/EP02/13411

(30) Foreign Application Priority Data
Dec. 6, 2001 (EP) 101 60 058.5

(51) Int. Cl. G06F 19/00

(52) U.S. Cl. 701/56; 701/51

(57) ABSTRACT

In a device for controlling at least one control or regulating system arranged in a vehicle. Means are provided for detecting a driving style quantity classifying the driver's driving style. The operation of at least one control or regulating system is automatically adapted to the driver's driving style as a function of the driving style quantity. In addition, means are provided for allowing the driver to modify the operation of the control or regulating system that has been automatically adapted to his driving style.

This application claims the priority of German patent document 101 60 058.5, filed 6 Dec. 2001 (PCT International Patent Application No. PCT/EP02/13411, filed 28 Nov. 2002), the disclosure of which is expressly incorporated by reference herein.

### BACKGROUND AND SUMMARY OF THE INVENTION

The invention relates to a method and apparatus for controlling at least one control and/or regulating system in a vehicle.

Devices and methods of the generic type are known from the prior art in many modified forms. For example, German patent document DE 42 33 938 A1 discloses a shifting device for an automatic transmission of a motor vehicle, which is controlled by an electronic control unit. The shifting device provides a selector lever, which can be pivoted in either of two perpendicular planes. The drive positions “P”, “R”, “N” and “D” are selected in the one pivoting plane, while individual gear upshift limitation steps can be shifted by manipulating the selector lever in the other. In this example, the selector lever is preferably a steering column lever. A recall from the gear upshift limitation steps is possible by pressing the lever down out of the shift position “D”. With this automatic transmission, the different gears are provided in fixed pre-specified steps, which are determined in accordance with a stored shifting program according to the speed of the vehicle. A step can be shifted to the next higher or next lower gear by means of the selector lever. A driving style adaptation is not provided with this automatic transmission. However, the driver is able to set different driving programs by turning a knob.

A control system for a gearbox is disclosed in U.S. Pat. No. 5,425,686, in which the driver can shift the mode of operation of the transmission between an automatic mode, a semi-automatic mode and a manual mode. A driving style adaptation is not provided with this transmission.

In a control system for an automatic transmission disclosed in U.S. Pat. No. 5,436,834, shifting points for the transmission are matched to the behavior of the driver. The engine torque and the vehicle acceleration are evaluated for this purpose. The driver has no way of retrospectively controlling the adaptation of the shifting points that has been made, in accordance with his own conceptions, by means of so-called trimming within certain limits.

An arrangement for controlling the gear shifting of an automatic transmission of a motor vehicle is disclosed in German patent document DE 43 32 265 C1, in which the basic shifting program can be controlled adaptively. The shifting program is adapted depending on the operation by the driver of a selector device, with which the driver extends or reduces an upshift limitation. The driver has no way of retrospectively controlling the adaptation of the shifting points that has been made, in accordance with his own conceptions, by means of so-called trimming within certain limits.

German patent document DE 44 01 416 C2 discloses a method for gradually classifying a driving style between a calm and a dynamic style of driving. For this purpose, measured quantities indicative of driving style are scanned during a journey by means of a vehicle sensor system, and at least one driving style indicator is determined by means of at least some of the recorded measurements using an associated previously stored measured quantity/driving style characteristic in each case. In this manner, it is possible to determine an acceleration indicator describing acceleration behavior, a braking indicator describing braking behavior and a steering indicator describing the steering behavior. These quantities can then be used to adjust the input parameters for control or regulating devices of different control or regulating systems, to adapt the driving style of a motor vehicle dependent in a specifically definable manner on the acceleration, braking and/or steering indicator.

The operator's driving style is classified separately with regard to the acceleration behavior, the braking behavior and the steering behavior, in order to take into account the fact that the driving style cannot usually be satisfactorily classified by means of a single indicator. Rather, it has been shown that it is expedient in this regard to consider the longitudinal and the transverse dynamics separately and, furthermore, to differentiate between the acceleration and braking behavior of the longitudinal dynamics. In comparison with a more relaxed driving style, a dynamic driving style is characterized by rapid acceleration, late but severe braking, and high transverse accelerations around curves. In the latter case, that the operator may not control, for example, the gas pedal, brake pedal or steering wheel angle (which represent his control quantities); accordingly, the control comparison takes place with the vehicle accelerations in the longitudinal and transverse direction, about which he receives visual and tactile feedback. As a result, the operator's wish is automatically detected during his driving style so that the system can be adjusted in good time. There is no provision for the driver to be able to control retrospectively the adaptive adjustments to his driving style of the control or regulating devices that have been made, in accordance with his own conceptions, by means of so-called trimming within certain limits.

The above-described methods and devices, in which control or at least one control and/or regulating system arranged in a vehicle is automatically adapted to the driver's driving style, have the following disadvantage: the driver has no way of consciously modifying the automatic control of the operating mode that has been implemented based on his driving style. That is, the driver has relinquished his control over the control and/or regulating system, and cannot intervene in the system to adjust it according to his own wishes.

One object of the present invention is to provide an improved method and apparatus for automatically adapting the operating mode of a control and/or regulating system to a driver's driving style as a function of a driving style quantity, and to improve the support given to the driver.

This and other objects and advantages are achieved by the method and apparatus according to the invention, which includes means for detecting a driving style quantity classifying a driver's driving style. The at least one control and/or regulating system is then controlled in such a way as to automatically adapt the operating mode of the control and/or regulating system to the driver's driving style as a function of the driving style quantity. In addition, means are provided with which the driver can exert control over and modify the operating mode of the control and/or regulating system that has been automatically adapted to his driving style according to objective criteria.

Other objects, advantages and novel features of the present invention will become apparent from the following detailed description of the invention when considered in conjunction with the accompanying drawings.

### BRIEF DESCRIPTION OF THE DRAWINGS

FIG. 1 shows part of a vehicle's electrical system; and

FIG. 2 is a schematic representation of components which enable the driver to modify an operating mode of a control and/or regulating system that has been adapted to his driving style.

### DETAILED DESCRIPTION OF THE DRAWINGS

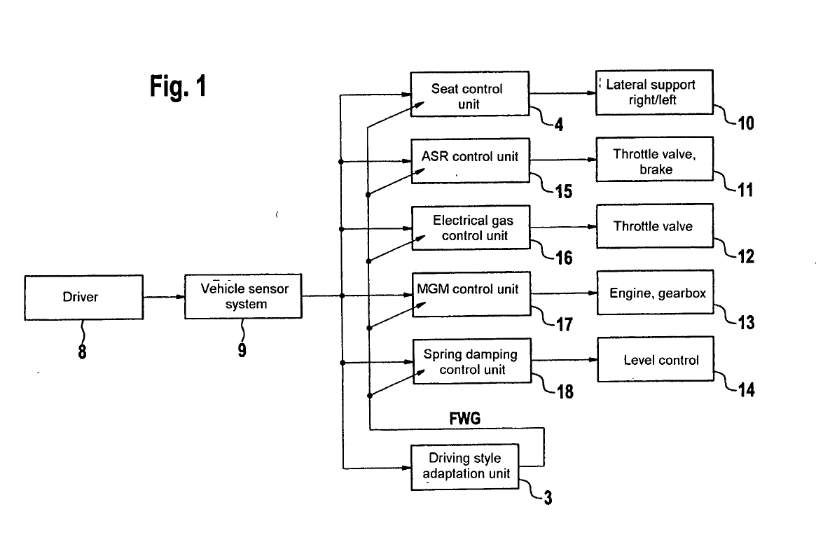

An electrical system is shown in FIG. 1, for a vehicle which includes a seat, a drive slip regulator (ASR) an electronic gas pedal, an engine gearbox management system (MGM) and a spring damping system as a control or regulating system. A central unit is provided for each of these systems, which, for simplicity and also in the case of actual regulator systems, is described in the following as a control unit. The seat control unit 4 controls the lateral support 10 on the left and right of a seat, for example of a driver's seat. Details of such a control are disclosed, for example, in German patent document DE 197 50 223 A1, the contents of which shall be part of the present description. The ASR control unit 15 controls throttle valve and brakes 11 to prevent excessive drive slip in the case of propulsive thrust. The electrical gas control unit 16 controls the throttle valve 12 depending on the operation of the gas pedal by the driver. The MGM control unit 17 controls both the engine and the gearbox 13, and the spring damping control unit 18 controls the vehicle level regulator 14.

Connected to the input side of the control units are the required output signals of a vehicle sensor system 9, which measures the necessary quantities resulting from the behavior of the driver 8 during a journey (i.e., due to the actuation of the steering wheel, the gas pedal or the brake pedal, for example). Normally, the following quantities are fed to the individual control units: Transverse acceleration and vehicle speed are fed to the seat control unit 4. The speeds of the individual wheels are fed to the ASR control unit 15. At least one quantity, which represents the driver's actuation of the gas pedal, is fed to the electrical gas control unit 16. Quantities, which represent the driver's commands, the operating state of the engine and the operating state of the transmission are fed to the MGM control unit 17. Quantities representing longitudinal, transverse and vertical accelerations of the vehicle, the slew rate, the angle through which the steering wheel is turned, and the wheel loads as well as quantities, which represent the level of each individual wheel, for example, are fed to the spring damping control unit 18.

In addition to the systems listed above, the motor vehicle has the benefit of an anti-lock braking system (ABS) in a manner, which is not explicitly shown.

In addition, the output signal of a unit 3 for adapting the driving style acts on the input parameters of the respective control units, in such a way that the latter are adapted in their control behavior to a particular driving style, which lies gradually between a very calm and a very dynamic driving style. Depending on the driving style prescribed by the driving style adaptation unit 3, the control units therefore control their respectively associated actuating elements in different ways. Hence, when a relaxed driving style is prescribed, the seat behaves with an accent on comfort, the ASR behaves stably, the electrical gas regulator insensitively, the spring damping system with an accent on comfort and the MGM according to consumption-optimized gearshift characteristics. On the other hand, when a dynamic driving style is prescribed, the seat behaves insensitively, the ASR with powerful traction, the electrical gas regulator sensitively, the spring damping system in a sporty manner and the MGM according to sporty gearshift characteristics. Between these two extremes, the control or regulating behavior that has been adapted for the currently determined driving style can be adjusted gradually in a large number of steps or continuously.

The driving style, to which the control units are matched, is determined by the driving style adaptation unit 3 based on selected output signals from the vehicle sensor system 9. For this purpose, the required sensor signals, which are indicative of the driving style (and are specified in more detail below) are fed to said driving style adaptation unit. On the basis of these measurements, the driving style adaptation unit 3 determines the appropriate driving style based on a classification according to the method described in the following. This is stored as a program in a memory in the driving style adaptation unit 3, which also contains the further hardware required for the described driving style classification. The latter comprises components which are familiar to the person skilled in the art and need not therefore be shown in more detail here.

For classification of the driving style, the method provides for the separate determination of indicators for longitudinal acceleration behavior, the braking behavior and steering (i.e., transverse acceleration) behavior. In this case, larger indicators correspond to a more dynamic driving style. For the determination of each of the three indicators, the front wheel speeds left and right, the status of an ASR information lamp, the power to weight ratio of the vehicle and, optionally, the state of the reversing lamp are recorded as measured quantities indicative of the driving style recorded by the vehicle sensor system 9. In addition, the throttle valve demand and, optionally, the position of a kick-down shift are recorded for determining the acceleration indicator; the state of the brake light shift and, optionally, information on the state of the ABS regulator are recorded for determining the braking indicator; and, optionally, the steering wheel angle and, also optionally, the transverse acceleration are recorded for determining the steering indicator.

The recording of quantities designated as “optional” can be carried out by means of appropriate sensors, as long as these are provided in the vehicle sensor system 9. Otherwise, the appropriate values are calculated indirectly from the measurements of the wheel speeds and/or the throttle valve demand. Inaccuracies in this regard do not significantly affect the result of the classification. If the information from the reversing light is omitted, then reverse driving maneuvers are also classified. Although the method is not basically designed for this, no errors or only negligibly small errors result.

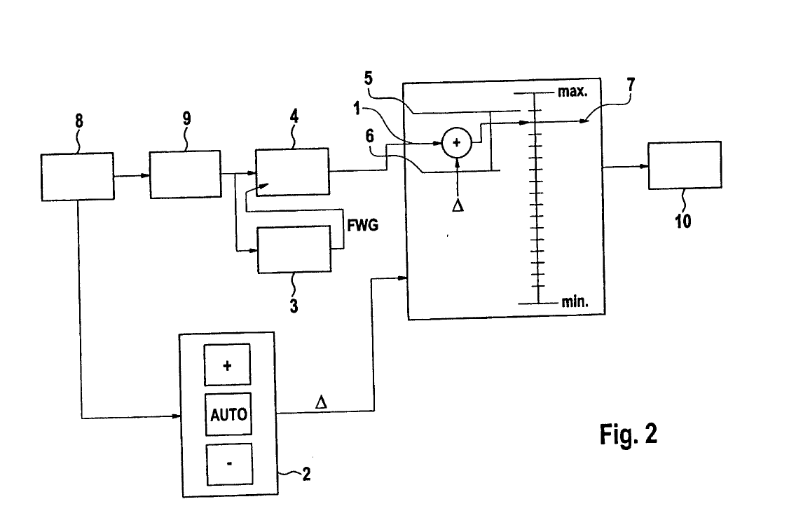

FIG. 2 is a schematic representation of those components which are required to enable the driver to modify an operating mode of a control and/or regulating system that has been adapted to his driving style.

The following description is based, by way of example only, on a so-called dynamic driving seat as a control or regulating system, such as is described in German patent document DE 197 50 223 A1, referred to previously. In place of such a dynamic driving seat, any of the control or regulating systems shown in FIG. 1 or other control or regulating systems not dealt with in the present exemplary embodiment can be used in a corresponding manner.

In a dynamic driving seat, the right and left lateral support 10 are adjustable, preferably steplessly.

As shown in German patent document DE 197 50 223 A1, in a dynamic driving seat, the lateral support is adjusted by feeding compressed air to air cushions built into the seat, via solenoid valves. Consequently, the air pressure determines the amount of lateral support. The following is to be understood by a stepless adjustment of the lateral support: for the operation of the dynamic driving seat, a range of values is specified, within which the value of the air pressure of the compressed air supplied to the air cushions can move. At the same time, the solenoid valves are controlled so that this air pressure can assume any value within this range of values. If the air pressure changes, this change should occur continuously. As the air pressure can be adjusted steplessly, the lateral support can also be adjusted steplessly.

A stepped adjustment of the lateral support is also possible as an alternative to a stepless adjustment. In this case, the air pressure can only assume individual, discrete values within an associated range of values; and change in the air pressure no longer occurs continuously, but in the form of steps. Here, the difference between individual, adjacent values must be sufficiently small, however, that these values lie close to one another and that thus a quasi-stepless impression is obtained and the control or regulating system can be seen as a quasi-stepless settable or adjustable system.

The above comments on a stepless or stepped adjustment also apply in a corresponding manner to the control or regulating systems shown in FIG. 1 and to other systems not shown in this Figure.

As already described in conjunction with FIG. 1, the output signals of a vehicle sensor system 9, which records the necessary measured quantities resulting from the behavior of the driver 8 during a journey, are fed to the input side of the seat control unit 4, and to the driving style adaptation unit 3. The latter determines the driving style quantity FWG as a function of these output signals, and supplies it to the seat control unit 4, which automatically adapts the operating mode of the seat control unit 4 to the driver's driving style as a function thereof. That is, the seat control unit 4 determines a control quantity 1 as a function of the output signals of the vehicle sensor system 9 fed to it, in accordance with the operating mode that has been set as a function of the driving style quantity FWG.

As shown in FIG. 2, the system according to the invention includes a further control device which the driver 8 can operate to modify the operating mode of the seat control unit 4 that has been adapted to his driving style. In the illustrated embodiment, the control device 2 has three buttons. By pressing the “Auto” button, operation of the control and/or regulating systems, including the seat control unit 4, are automatically adapted to the driver's driving style as a function of the driving style quantity FWG. By pressing the two buttons “+” and “−”, the driver can modify the operating mode of the control and/or regulating system, including the seat control unit 4, that has been adapted to his driving style. If the driver has not pressed the “Auto” button, then the control and/or regulating systems will be in an operating state in which no adaptation of their operating mode to the driver's driving style takes place. An evaluation of the operation of the two buttons “+” and “−” is not provided in this operating state. As an alternative to this design, it is also possible that the two buttons “+” and “−” are also evaluated, even if the “Auto” button has not been pressed. In this design, the control and/or regulating systems can be operated entirely in a manual mode.

Alternatively, control 2 device may have only the two buttons “+” and “−”. In this case, the control and/or regulating systems are set permanently so that their operating mode is automatically adapted to the driver's driving style as a function of the driving style quantity FWG. The driver is unable to deactivate this function.

If a calm driving style is detected in the means of detection device 3, then the operating mode of the seat control unit 4 is adapted so that the lateral support of the seat tends to be set to minimum. If, on the other hand, a sporty driving style is detected, then the operating mode of the seat control unit 4 is adapted so that the lateral support of the seat tends to be set to maximum. As long as the driver does not operate either of the “+” and “−” buttons, the left and right lateral support 10 is set according to the automatically determined control signal 1.

As soon as the driver operates one of the two “+” and “−” buttons, the control signal 1 provided by the seat control unit 4 is trimmed according to the demand signal A, which results from the operation of the buttons “+” and “−”, resulting in the actual control signal 7. The demand signal A resulting from the operation of the “+” and “−” buttons is positive when the “+” button is pressed and negative when the “−” button is pressed. The actual control signal 7 is given by superimposing the demand signal A on the control signal 1, as shown in FIG. 2.

As a result of trimming the control signal 1 with the demand signal A, the driver 8 can modify the operating mode of the seat control unit 4 that has been adapted to his driving style. The driver 8 can thus change the control signal 1 for the lateral support that has been automatically determined based on driver-dependent regulating/control quantities, by operating the “+” and “−” buttons. The value A that is thereby set increases the control signal 1 when the “+” button is pressed or reduces it when the “−” button is pressed. The trimmed control signal 7 determines the setting for the right and left lateral support 10 when the driver has modified the operating mode of the control and/or regulating system that has been adapted to his driving style.

If the trimmed control signal 7 exceeds an upper trim limit 5 or falls below a lower trim limit 6, it is set to a maximum value, which corresponds to the upper trim limit 5, or to a minimum value, which corresponds to the lower trim limit 6 respectively. As a result, the trimmed control signal 7 always remains within a specified range of values.

The scale shown in FIG. 2, which ranges from a value “min” to a value “max”, shows the possible range of adjustment of the control signal 1 when no trimming is carried out by the driver, or of the trimmed control signal 7 when trimming is carried out by the driver. The range of the trim, which is specified by the lower and upper trim limit, typically corresponds to 5-10% of the total adjustment range.

Trimming can take place continuously or in discrete steps. The trim range lies between the lower trim limit 6 and the upper trim limit 5. The trim limits 5 and 6 lie within the adjustment range and, if required, can correspond to the limits of the adjustment range.

The trim control device 2 can be used in all control and/or regulating systems, the operating mode of which is automatically adapted to the driver's driving style as a function of a driving style quantity (FWG). As already mentioned, all the control and/or regulating systems in FIG. 1 come into consideration in this regard. As a further example, although not shown in FIG. 1, the control device 2 may be used with a steer-by-wire system, in which the steering ratio is automatically adjustable.

In the individual control and/or regulating systems in FIG. 1, the driver can take control (i.e., modify the operating mode of the control and/or regulating system that has been adapted to his driving style) by trimming as follows:

Seat Control Unit 4:

A dynamic driving seat incorporated into the vehicle is adjusted with the help of the seat control unit. Compressed air is fed into the air cushions fitted in the seat as a function of the transverse acceleration and vehicle speed that are fed as input signals to the seat control unit. When the operating mode of the seat control unit is automatically adapted to the driver's driving style, the basic pressure supplied to the air cushions is set according to the driver's driving style. The modification carried out by the driver now affects the value of this basic pressure.

ASR Control Unit 15:

The modification carried out by the driver usually leads to a change in the slip thresholds. That is, the response of the ASR system is modified. As an alternative or in addition, it is also possible to control the transitional behavior of an ASR system from a first operating state (in which an ASR control has taken place) to a second operating state (in which no further ASR control is required). That is, control can be exerted, for example, over how much time should elapse between an intervention in the throttle valve that limits the engine torque to achieve an intervention in the throttle valve that represents full load operation of the engine.

Electrical Gas Control Unit 16:

In this case, the driver can alter the characteristic of the gas pedal, which describes the movement of the throttle valve as a function of the operation of the gas pedal.

MGM Control Unit 17:

The driver can control the shift characteristics, which control the gas pedal positions at which upshifting or downshifting takes place, for example.

Spring Damping Control Unit 18:

In this case, the driver can control the spring stiffness, for example.

As well as the affecting of the control signal by the driver shown in FIG. 2 in order to modify the operating mode of a control and/or regulating system that has been adapted to his driving style, further possibilities of affecting this signal are also possible. Thus, the driver can also modify the control or regulating law on which the control or regulating system is based, for example, or he can affect certain parameters.

To summarize, the invention concerns a device for setting up a steplessly or quasi-steplessly adjustable system, the adjustment being realized using an automatic function and an operating function. By operating a control device 2, the control quantity 1 determined by the automatic function (i.e., by an appropriate control unit) is increased or decreased by a specified value A by means of trimming. The automatic function can take place by means of a driving style classification, for example. An automatic control or regulation of individual vehicle functions is carried out by means of the driver's acceleration, braking and steering behavior. The operating function now enables these automatically adjusted functions to be changed by a predetermined value in the plus or minus direction depending on the setting. This predetermined value is preferably 10-15% of the total variation range. If the driver's driving style now changes from a relaxed to a sporty driving style during the journey, the appropriate automatically determined value is always incremented or decremented by the value set on means of control.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-5. (canceled)

6. A device for controlling at least one control or regulating system in a vehicle, comprising:
means for detecting a driving style quantity classifying a driver's driving style;
means for automatically adapting operation of the at least one control or regulating system to the driver's driving style as a function of the driving style quantity; and
a control device operable by the driver to modify the operation of the control or regulating system that has been adapted to his driving style; wherein:
a demand signal determined by the control device is additively superimposed on a control quantity determined by the at least one control or regulating system for controlling actuating elements associated with the at least one control or regulating system, to generate a trimmed control signal; and
the actuating elements are controlled by means of the trimmed control signal.

7. The device as claimed in claim 6, wherein the trimmed control signal lies within a specifiable trim range arranged around the control quantity.

8. The device as claimed in claim 7, wherein:
the trimming range is defined by a lower limiting value and an upper limiting value; and
the limiting values can lie within or coincide with a total variation range of the control signal.

9. The device as claimed in claim 7, wherein:
if the control quantity exceeds the upper limit value, the trimmed control signal is set to the maximum value of the control quantity; and
if the control quantity falls below the lower limit value, the trimmed control signal is set to the minimum value of the control quantity.

10. A method for controlling at least one control or regulating system arranged in a vehicle, said method comprising:
determining a driving style quantity which characterizes a driver's driving style;
automatically adapting operation of the at least one control or regulating system to the driver's driving style as a function of the driving style quantity; and
said driver modifying the operation of the at least one control or regulating system that has been adapted to his driving style by actuating a control device;
wherein said modification of the operation of the at least one control or regulating system that has been automatically adapted to the driver's driving style is carried out by,
said control device generating a demand signal;
additively superimposing the demand signal on a control quantity which is determined by the control or regulating system for controlling actuating elements associated with the control or regulating system; and
controlling the actuating elements by means of the trimmed control signal.
